(19) United States
(12) Patent Application Publication
(10) Pub. No.: US 2016/0152177 A1
(43) Pub. Date: Jun. 2, 2016

(54) METHOD AND APPARATUS FOR SELECTIVE BLANKING OF A LICENSE PLATE USING MULTIPLE LIGHT SENSORS

(71) Applicant: NOLIMITS ENTERPRISES INC., INDEPENDENCE, KY (US)

(72) Inventor: Jonathan Dandrow, Cheshire, CT (US)

(73) Assignee: NOLIMITS ENTERPRISES INC., INDEPENDENCE, KY (US)

(21) Appl. No.: 14/989,773

(22) Filed: Jan. 6, 2016

Related U.S. Application Data
(63) Continuation-in-part of application No. 13/438,944, filed on Apr. 4, 2012, now Pat. No. 9,270,407.
(60) Provisional application No. 61/472,384, filed on Apr. 6, 2011.

(51) Int. Cl. B60Q 1/56; H05B 37/02

(52) U.S. Cl. CPC B60Q 1/56; H05B 37/0218

(57) ABSTRACT

A blanking device generates a blanking signal to obscure signals on a license plate in response to a monitoring flash directed at the license plate. The device includes at least two sensors spaced apart to enable the device to differentiate between a monitoring flash from a device attempting to take an image of the license plate and other spurious signals.

### RELATED APPLICATIONS

This application is a continuation-in-part of application Ser. No. 13/438,944 filed Apr. 4, 2012, which in turn claims priority to provisional application Ser. No. 61/472,384 filed Apr. 6, 2011 and incorporated herein in their entirety

### BACKGROUND OF THE INVENTION

A. Field of Invention

This invention pertains to an apparatus and method for selectively blanking a license plate, said apparatus including one or more light sources embedded in a support associated with the license plate on a motor vehicle, the light sources firing on demand to illuminate the license plate, rendering it unreadable. Importantly several light sensors are used to trigger a control circuit activating the light sources.

B. Description of the Prior Art

Motor vehicles, and, by extension, the owners of motor vehicles, are uniquely identified by their license plates. However, the license plates of motor vehicles are routinely photographed or videotaped by many entities in various locations without permission from the owners of the respective motor vehicles. Since most entities, especially private entities, do not have the right to monitor the license plates of motor vehicles, these activities often constitute flagrant violations of the expectations of privacy of the respective individuals. The present invention provides a means of preventing such privacy violations.

### SUMMARY OF THE INVENTION

Briefly, the present invention provides a plate assembly that prevents an external monitoring device from making a useful image of a motor vehicle license plate. Typically, monitoring devices for performing such recording include a camera and a generator producing a monitoring flash consisting of at least one short burst of radiation that could be either in the visible light range or in the infrared range. The monitoring flash is a precursor to the actual recording and is used to insure that the motor vehicle and license plate are properly illuminated and/or to focus a camera associated with or incorporated into the monitoring device. Because it is important to obtain a clear image of the license plate, some monitoring device include means for generating a first monitoring flash used to determine the actual distance from the monitoring device (or camera) to the license plate.

Moreover, some monitoring device may include two cameras spaced apart from each by several feet and arranged to provide better coverage for the monitoring device. In such an arrangement, two monitoring flashes may be generated for each camera; the first being used to determine the distance to the license plate and the second for illuminating the license plate for a good image. Of course, typically, the two cameras do not take the image at exactly the same time but one may be delayed somewhat with respect to the other.

The present invention detects the monitoring flashes and, in response, generates a blanking flash in the form of an intense light beam directed at shallow angle at the license plate thereby blanking the license plate for a short time period. This blanking lasts long enough to coincide with the generation of an image by the camera and insure that the image is useless.

Specifically, after releasing the monitoring flash, the recording device triggers the camera and the camera then captures either a single image (for a photograph) or a plurality of images (for a video clip). In the present invention, the intense light pattern from the blanking flash causes the license plate to appear as a featureless or bright surface and the license plate in any image or images taken by the cameras appear blank because the camera's light sensors become oversaturated. As a result, the alphanumeric (or other) characters on the license plate will be invisible, or at least partially obstructed so that they cannot be recognized.

If a second monitoring flash is detected within a very short time period after the first one, then it is assumed that the first monitoring flash was intended for metering and the second monitoring flash was intended to generate an image of the license plate and, accordingly, the second monitoring flash is followed by a second blanking flash. Preferably the intensity of the second flash is equal to or higher than the first. As previously mentioned, some monitoring devices may be using four sets of monitoring flashes, two for each of two cameras. Since normally there isn't enough time between the operations of the cameras to recharge the charging circuitry driving the flash generators for the blanking flashes, preferably, four separate flash generators are provided.

In one embodiment, of the invention, a flash suppression means is also provided which discharges the control circuit used to drive the blanking flash generators.

Another feature of the invention is that an edge detection circuit is provided to detect monitoring flash(es) and differentiate them from other events resulting in a sudden increase of light intensity on the license plate. The circuit includes at least two photo sensors, the two sensors being disposed at spaced relationship from each other. Each set includes at least photo diode or other similar sensor adapted to sense a monitoring flash and generate a corresponding electrical output. The edge detector looks for edges from both sets of photo sensors and triggers the light source control circuit only when the edges are detected substantially simultaneously by the two sets of light sensors.

### BRIEF DESCRIPTION OF THE DRAWINGS

FIG. 1 shows plan view of a license plate assembly constructed in accordance with this invention;

FIG. 2 shows a block diagram of the apparatus of FIG. 1;

FIG. 3 shows a typical circuit used in the apparatus of FIG. 2;

FIG. 4A shows the output of two typical spaced photo sensors when hit by a monitoring flash;

FIG. 4B shows the output of two typical spaced photo sensors when hit by another source, such as a conventional headlight beam from a car; and

FIG. 5 shows an embodiment with an edge detector differentiating between a monitoring flash and other light sources.

### DETAILED DESCRIPTION OF THE INVENTION

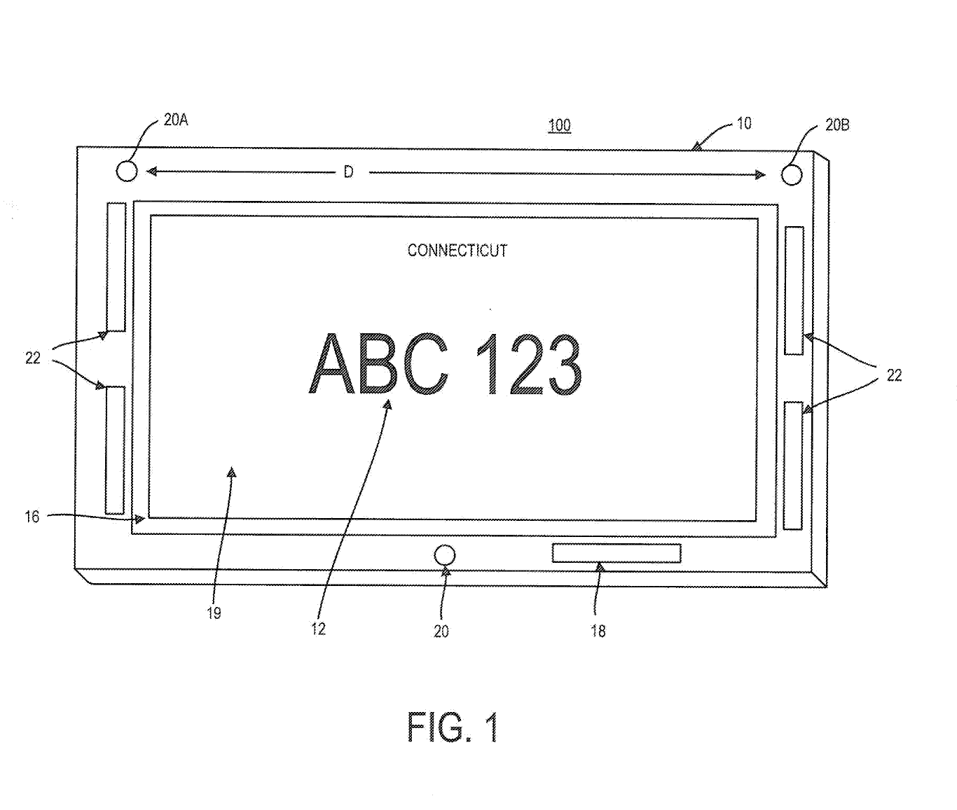

Referring first to FIG. 1, preferably, a license plate assembly 100 constructed in accordance with this invention assembly includes a frame 10 sized and shaped to fit around a license plate 12. The license plate 12 is a standard license plate issued by the appropriate authorities and it bears several alphanumeric characters and/or other images.

The frame 10 is preferably made of a suitable plastic material and includes a bezel that forms the outside surface of the frame 10 and includes peripheral lip 14 that extends over and covers the peripheral edges 16 of plate 112 as shown. The bezel may be raised to provide sufficient room for the flash generators. The generators may be sealed and protected by a transparent cover of a plastic material such as acrylic, Lexan®, tampered glass, or other similar transparent materials.

The assembly 100 includes a control component 18 that can be powered by one or more batteries (not shown) dedicated for the component and included in the frame 100. However preferably, the assembly 100 is powered from the car battery (not shown) using standard wire connectors (not shown). In one embodiment, the assembly 100 includes a flash sensor 20 arranged and constructed to sense one or more monitoring flashes as discussed in more detail below.

The sensor 20 is connected to the component 18, which controls the operation of several flash generators 22. In FIG. 1, four such flash generators 22 are shown, it being understood that their number and positions may be changed as desired. The flash generators 22 are arranged to generate blanking flashes in forms of high intensity beams of light that blank license plate 12 as discussed below.

The positions of the component 18 and sensor 20 within frame 10 may be changed as well. If there is not enough in the frame, component 18 may be installed behind the license plate 12 and the sensor 20 may be disposed remotely from the plate 12.

Preferably, the frame 100 is formed with appropriate cavities for housing the component 18, sensor 29 and flash generators 22. The bezel is placed over the cavities and secured to the rest of the frame 10 thereby sealing these cavities to keep the component 18, sensor 20 and flash generators 22 so that they will not come into contact with water (during rain and snow) and other materials, such as salt, etc. The cavities (not shown) holding the flash generators 22 can be coated with a reflective coating that directs light from the flash generator toward the license plate 12. A portion of the bezel disposed above the sensor 20 is made of clear or transparent material that allows radiation to enter into and be sensed by sensor 20. In an alternate embodiment, an IR filter may be placed above the sensor 20 to eliminate the effects or reduce the effects of ambient light.

The flash generators 22 are constructed and arranged to generate a high light pattern directed at plate 12. In FIG. 1, the flash generators 22 are positioned along the lateral sides, but they may be provided above and in below the license plate 12 as well.

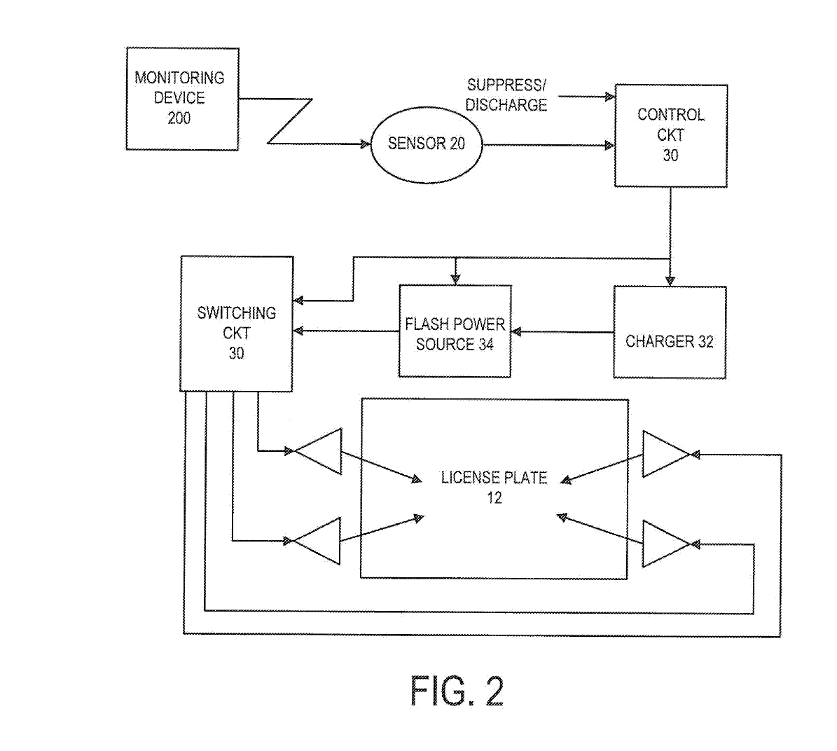

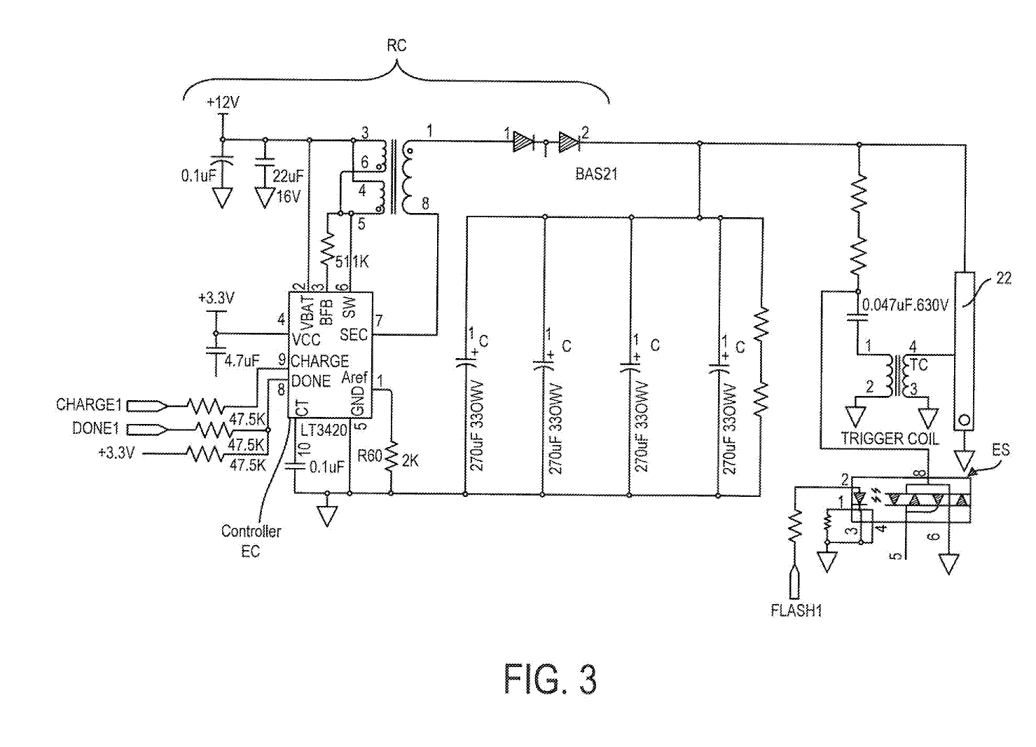

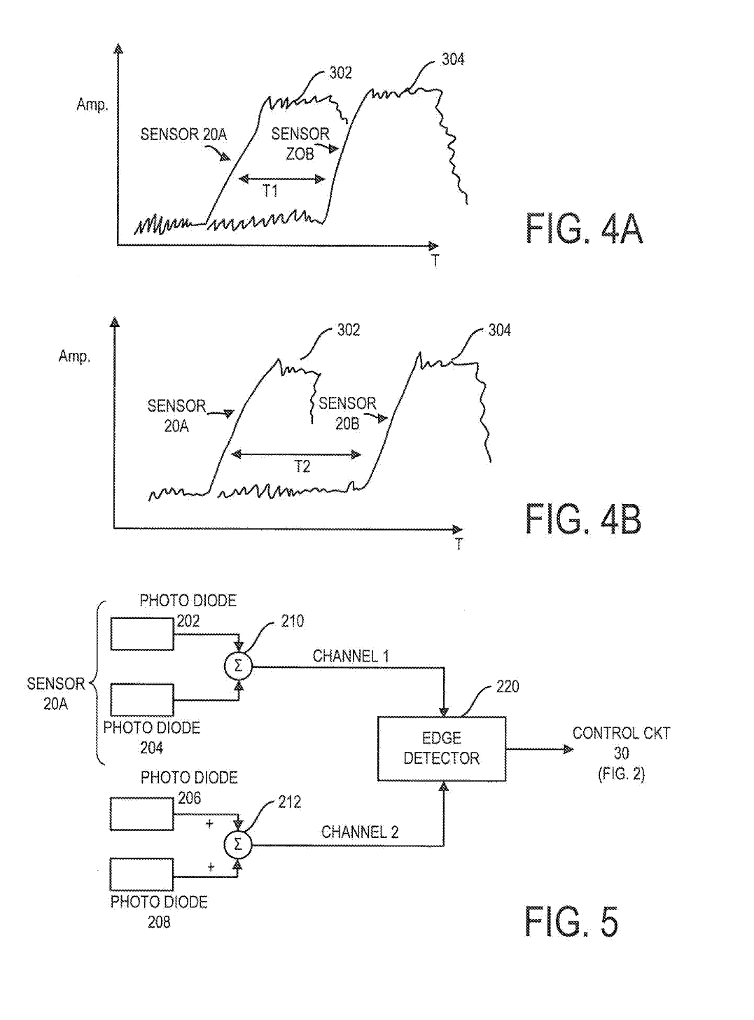

The bezel and lip 14 perform several functions. They hides and protects the circuitry shown in FIGS. 2 and 3. They make the frame 10 look like any other license plate frame so that the frame 10 is essentially undistinguishable from a standard license plate unless it is removed. The lip also limits the light pattern generated by flash generators 22 at license plate 12 and prevents this light pattern from propagating into the eyes of other drivers in the vicinity.

FIG. 2 shows a schematic circuit diagram for the 100 apparatus and electric component 18. As can be seen in this Figure, the component 18 includes a control circuit 30, a charger circuit 32, a flash power source 34, and a switching circuit 36. The switching circuit receives high energy pulses from the power sources 34 and directs them to one of the flash generators as required, under the control circuit 30. It should be understood that the diagram of FIG. 2 is somewhat schematic to describe functionally how the various elements of component 18 interact.

FIG. 3 shows a more detailed diagram illustrating how a particular flash generator 22 is operated. The flash generator 22 is connected to a bank of capacitors C. The capacitors C are charged under the control an electronic controller EC. When the circuit shown in FIGS. 2, 3 is disposed in a motor vehicle, when the motor vehicle is started up, the controller EC receives a CHARGE command from the control circuit 30, and in response charges the capacitor bank C. When the capacitor bank C is charged, the controller EC generates an indication DONE to the control circuit 30. When the control circuit sends a command FLASH, this command activates an electronic switch ES which causes through a trigger coil TC, the capacitor bank C to discharge into the flash generator 22 thereby generating a blanking flash.

The operation of the assembly 100 of FIG. 1 and the circuitry of FIGS. 2 and 3 is now described. As discussed above, once the motor vehicle is operating, the capacitor bank C is charged and ready for action. Typically monitoring device 200 starts the process of obtaining an image of license plate 12 by generating at least one monitoring flash. This monitoring flash is sensed by the sensor 20 and a flash detect signal is sent to the control circuit 30. The control circuit 30 generates a FLASH signal to a first flash generator 22. The respective flash generator then generates a first blanking flash. If no further monitoring flashes are detected within a couple of seconds, it is assumed that the monitoring device generates only a single flash. If a second monitoring flash is detected by sensor 20, this information is passed on to the control circuit 30 which then triggers another flash generator 22 and a second blanking signal is generated. As mentioned above, in some instances, some monitoring devices can generate up to four monitoring flashes, a set of two for each of two cameras (not shown), and the control circuit 30 in this instance generates four sequential monitoring flashes by triggering once each of the four generators.

Since it is expected the first and third monitoring flashes are used to determine the distance from the cameras to the license plate and the second and fourth monitoring flashes are the ones used to illuminate the license plates, the system 100 is arranged so that the second and fourth blanking flashes have higher intensities (e.g., by 20-50%) to insure that the license plate is blanked (or, more accurately, the sensors of the cameras in the monitoring device are overloaded) and the alphanumeric characters (or any other images) on the license plate will be either invisible or at least unreadable on any images obtained by the camera.

The flash generators are typically strobe-type devices.

As soon as a blanking flash is generated, the capacitor bank is recharged by recharging circuit RC automatically to the nominal voltage value. Usually it takes about 3 seconds to recharge the bank of capacitors C.

The energy stored in the capacitive bank is relatively high and touching any terminals of the bank could be dangerous. Therefore safety elements (not shown) may be added that automatically discharge the capacitor bank through a dummy load (not shown) or other means. This operation may be initiated by a SUPPRESS FLASH signal the control circuit 30. Various conditions can trigger this signal, such as turning the engine off, dismounting the frame 10, etc.

The electronic circuitry shown in FIGS. 2 and 3 may be somewhat sensitive to light from other sources, such as street lights, headlights from other cars, etc. Therefore, in an alternate embodiment, of the invention, instead of a single light sensor 20, at two sensors 20A, 20B are used. Alternatively, pairs of sensors As shown in FIG. 1, these sensors 20A, 20B are separated by a predetermined distance D. Preferably the distance D should be as large as possible. So in FIG. 1, the light sensors 20A, 20B are shown near the lateral edges of the frame 10. It has been found that if the sensors 20A, 20B are placed closer, the sensitivity of the system decreases. If necessary, D could be reduced to a couple of inches.

As cars and other automotive vehicles travel over various roads and highways, they are subjected to all kinds of light beams from various sources. This effect is especially prevalent at night. Thus, the cars and their light sensors 20, 20A, 20B could experience light beams or other light sources with varying intensity from street lights, traffic signals, bright advertisements, other cars. Some of these light sources, for example headlight beams, are concentrated in well-defined light beams. Other light sources, such as street lights are diffused. Moreover, in some instances, the sources change apparent intensity very quickly, for example, when the car exits from a dark tunnel, while other sources are fairly steady with either no changes in intensity or an intensity that that increases or decreases gradually. For example, light from halogen headlight lamps does not form a beam with very clear edges and when the lamps are turned on their intensity goes up slowly and not in a clearly defined step. The sensors in the present embodiment and the trigger circuitry driven by the sensor have been configured to differentiate between all these spurious lights beams or sources and one or more monitoring flashes.

More specifically, as shown in FIG. 4A, when a monitoring flash is directed at vehicle equipped with subject invention, its sensors 20A, 20B sense this flash and generate two respective signals 302 and 304, respectively. These signals 302, 304 occur almost simultaneously. In FIG. 4A the signal 304 is shown as being delayed by a period T1 for the sake clarity however in practice, this delay is very small.

On the other hand when another kind of light beam with a sharp rise time (or fall time) is detected by the sensors, because in almost all cases there is some relative movement either of the vehicle sensing the beam or the source generating the beam. As a result of this movement, the beam is not directed at the sensors simultaneously, but it sweeps across the back of the vehicle. As a result, when the sensors 20A, 20B detect this beam, they generate two corresponding beams 302, 304 that are separated by a much longer delay T2. Of course this delay is a function of the spacing between the two sensors 20A, 20B. For example, it has been found that in case of a headlight beam, this delay T2 may be in the range of 8,000 microseconds.

In the present invention, two different methods are used to differentiate monitoring flashes from ambient or other spurious light sources. First, an edge detector is used to differentiate between sharply defined beams of light that go on (or off) fairly quickly and other sources that change at a very small rate. For example, the edge detector may be configured to sense signals that rise (or fall) between two amplitudes in 1 microsecond or less.

Second, the delay between the two signals from the sensors is monitored. If the delay is longer than a preset threshold Ts, then the signals are ignored. Ts may be about 100 microseconds.

In the embodiment of FIG. 1 the electronic circuitry shown in FIG. 5 and discussed below is shown as being incorporated into a complete rectangular frame extending around the license plate 12. However a complete frame is not an absolute necessity and could be replaced by a single bar, preferably disposed along the top or the bottom edges of the plate 12. All the circuitry would then be imbedded in the bar. Moreover, in Fig., two sensors 2A, 20B are shown, however, each sensor could consist of two or more sensing elements, to improve the response time and sensitivity of the system.

FIG. 5 shows how the various elements discussed above are interconnected. In this Figure, sensor 20A includes two photo detectors 202, 204 and sensor 20B includes two photodetectors 206, 208. (As mentioned above, more or less sensing elements may be provided for each sensor). The outputs from the detectors 202, 204 are summed by an adder 210 and the outputs from the detectors 206, 208 are summed by adder 213. Of course, the outputs of the sensors may be combined in other ways, for example by performing on them another arithmetic operation, by taking the larger signal from each set of sensors, and so on. The outputs of the adders 210, 212 are defined as two channels 1 and 2.

The two channels 1 and 2 are then fed to an edge detector 220 that detects the edges of the signals from the channels and the delay between the signals. When an appropriate edge is detected from both channels AND the delay between the signals is no more than a threshold Ts then the edge detector generates an output to the control circuit 30 in FIG. 2. In turn the control circuit then initiates the generation of the blanking flashes as discussed above. The edge detector preferably includes a high pass filter to detect the edge of the signals from channels 1 and 2.

The circuits shown in FIGS. 2 and 5 can be implemented using either analog circuit elements or digitally using appropriate A/D conversion and a microprocessor.

Obviously, numerous modifications can be made to the invention without departing from the scope of the invention as defined in the appended claims.

I claim:

1. A blanking device for selectively blanking symbols on a license plate of a motor vehicle in response to a monitoring flash from a device configured to take an image of the license plate, the blanking device comprising:
a first and a second light sensor arranged to detect incident light, said light sensors being spaced away from each other by a predetermined distance, said first and second sensors generating respective first and second signals;
a signal analyzer receiving said first and second signals and being configured to differentiate said monitoring flash from other spurious light by detecting a delay between said first and second signals, and generating an output indicative of said monitoring flash; and
a blanking flash generator coupled to said signal analyzer and generating a blanking flash at the license plate in response to said monitoring flash, said blanking flash obscuring symbols on the license plate to the device.

2. The device of claim 1 wherein said signal analyzer includes a step detector adapted to detect a change in the amplitude of said signals.

3. The device of claim 2 wherein said signal step detector is adapted to detect a predetermined change in the amplitude of said signals within a predetermined time period.

4. The device of claim 1 wherein said signal analyzer is adapted to ignore said first and second signals when the delay between said first and second signals exceeds a predetermined threshold Ts.

5. The device of claim 1 wherein at least one of said light sensors includes at least one photo diode.

6. The device of claim 1 wherein each said light sensors includes at least two photo diodes.

7. The device of claim 6 wherein said signal analyzer includes a combiner combining detector outputs from said photo diodes.

8. A blanking device for selectively blanking symbols on a license plate of a motor vehicle in response to a monitoring flash from a device configured to take an image of the license plate, the blanking device comprising:
a first and a second light sensor arranged to detect incident light, said light sensors being spaced away from each other by a predetermined distance, said first and second sensors generating respective first and second signals, said first and second signals having respective signal amplitudes;
a signal analyzer receiving said first and second signals and being configured to differentiate said monitoring flash from other spurious light by detecting a change in said signal amplitudes and a delay between said first and second signals, and generating an output indicative of said monitoring flash;
a control circuit receiving said output and generating a corresponding trigger signal; and
a blanking flash generator generating a blanking flash at the license plate in response to said trigger signal, said blanking flash obscuring symbols on the license plate to the device.

9. The device of claim 8 wherein said analyzer is adapted to generate said output if (1) both said amplitudes rise by a predetermined amount within a first predetermined time period and (2) the delay between said signals is less than a second predetermined time period.

10. The device of claim 9 wherein each sensor includes at least two photo-diodes.

11. The device of claim 10 wherein said photo diodes each have respective diode outputs, said signal analyzer including a combiner combining said diode outputs.

12. The device of claim 11 wherein said combiner is an adder.

13. A method of blanking symbols on the license plate in the presence of a monitoring flash from a device configured to generate an image of the license plate, said method comprising the steps of:
detecting an incident light beam on said license plate using a first light senor and a second light sensor, said light sensors generating respective first and second sensor signals in response to said incident light beam;
determining a delay between said first and second sensor signals; and
generating an output signal to trigger a blanking flash on said license plate to obscure said symbols when said delay is less than a preselected threshold value Ts.

14. The method of claim 13 further comprising the steps of detecting respective edges in said first and said second signals based on a rise time of said first and second signals.
